(19) United States
(12) Patent Application Publication
(10) Pub. No.: US 2025/0165751 A1
(43) Pub. Date: May 22, 2025

(54) GRAPH PROCESSING SYSTEM AND METHOD USING SPARSE DECOMPOSITION

(71) Applicants: Yaochen HU, Montréal (CA); Yingxue ZHANG, Markham (CA); Mark COATES, Montréal (CA)

(72) Inventors: Yaochen HU, Montréal (CA); Yingxue ZHANG, Markham (CA); Mark COATES, Montréal (CA)

(21) Appl. No.: 18/516,880

(22) Filed: Nov. 21, 2023

(51) Int. Cl. G06N 3/0455; G06N 3/08

(52) U.S. Cl. CPC G06N 3/0455; G06N 3/08

(57) ABSTRACT

System, method, and computer readable medium for operating a computer system to process a graph, including receiving a prediction request for a subject node of the graph; obtaining a sparse node approximation for the subject node, the sparse node approximation defining a weighted combination of a subset of nodes of the graph as receptive nodes for the subject node; applying a neural network based transformation function based on the sparse node approximation to generate a node representation for the subject node; performing a prediction task based on the generated node representation to generate a prediction for the subject node; and outputting the prediction.

### RELATED APPLICATIONS

This is the first application for this matter.

### FIELD

This disclosure relates to a system, methods and computer readable medium for processing graph data structures.

### BACKGROUND

A graph is a data structure that models a set of entities as a set of respective nodes and the relationships between entities as a set of edges (E), such that graph [symbol] =( [symbol] ). A simplified example of a graph [symbol] =( [symbol] ) is shown in FIG. 1. Each node (individually denoted by a reference letter (z)) can be associated with a feature vector X_{z} and a label y. X can be used to denote and N X Dₒ matrix of all node features where the z^{th} row represents the features for node z, n represents the number of nodes (e.g., node size of the graph) and Dₒ represents number of dimensions (i.e., features x) included in node feature vectors. The edges (individually denoted by reference e) model the relationship between nodes z (e.g., roads between the cities (nodes) are connected by edges; chemical bonds; relations between people). The edge topology of a graph can be represented as an n by n adjacent matrix A. An edge element Aᵢⱼ is defined as 1 if and only if there is an edge between node zᵢ and node zⱼ, otherwise, it is defined as 0. In FIG. 1, Graph [symbol] contains nodes A, B, C, D, E, and F), having respective feature vectors X_{A}, X_{B}, X_{C}, X_{D}, X_{E}, X_{F}.

Graphs have great expressive power to model a set of entities and the relationships between entities in various fields such as social networks, recommendation systems, knowledge graphs, physical systems, protein-protein interaction networks, and many other complex systems, and therefore, are gaining a lot of attention in the field of machine learning.

FIG. 1 shows a general system architecture for an online prediction setting. Specifically, a client (user device 102) needs some prediction in respect of graph [symbol] and sends a request (for example, through a network that may include a cloud network such as the Internet) to a server 104. At the server 104, a graph neural network (GNN) model (GNN encoder 106) serves as a core building block of a prediction model. Although there are numerous designs for GNN models, the basic function of the GNN model is to represent each node based on its neighbourhood by aggregating features from neighbour nodes.

Upon receiving the request, the server 104 will compute node representations (also referred to as embeddings) using the GNN encoder 106 for specific nodes related to the request. With the node representations, some downstream procedure is further performed (e.g., by a decoder 108) to generate a prediction and return the final results to the client.

Node embedding or node representation is defined as mapping nodes to a D^{e}-dimensional embedding space (where D^{e}<<D (original dimensionality of the node)) so that similar nodes z in a graph [symbol] are mapped at close proximity in the embedding space. Similarity of nodes is quantified by different metrics which may or may not be domain/application specific.

A GNN is a type of neural network which directly operates on the graph structure. The goal of using a GNN is to provide an encoder function that can learn a low-dimensional vector also known as an embedding or representation g(z) of each node z in the graph [symbol] . A core building component of a GNN is called the message passing procedure, where the representation of each node is recursively updated over the aggregation of node features from its neighbors. Specifically, Let h_{z}^{l} be the embedding vector of node z at layer l. Denote N(z) as the set of neighbor nodes of node z. h_{z}^{l} is iteratively evaluated as:

$$\begin{matrix}{h}_{𝒩 ( z )}^{l} = {AGGREGATE}_{l} ( \{ {h}_{υ}^{l - 1} \vert ∀ υ ∈ 𝒩 ( z ) \} ) , \\ {h}_{z}^{l} = {UPDATE}_{l} ( {h}_{z}^{l - 1} , {h}_{𝒩 ( z )}^{l} ) ,\end{matrix} \qquad Equation ( 1 )$$

where AGGREGATEₗ(·) is any permutation invariant operation (a function over a sequence of inputs and the output is not affected by the order of the inputs) that aggregates a set of vectors, and UPDATEₗ(·) is any transformation function with possible learnable parameters and non-linear transformations. h_{z}⁰ is usually initialized as the row vector X_{z*} with node features. Finally, the representation of a node g(z) is defined as:

$$g ( z ) = {h}_{z}^{L} , \qquad Equation ( 2 )$$

where L is the predefined hyperparameter indicating the number of layers.

Deploying GNN models to process large graphs is challenging since collecting information from the neighbor nodes and computing the aggregation is extremely time-consuming. The processing time within a conventional GNN encoder 106, both for training and for inference, is inevitably long due to the number of computations required by a GNN model. The complexity of direct inference of each node representation in equation (2) is proportional to the number of receptive nodes. Specifically, for message-passing based GNN models, the number of receptive nodes potentially grows exponentially as the number of GNN layers increases. For the graph transformers, the number of receptive nodes is simply the full graph. Therefore, conventional GNN models are infeasible for applications with stringent latency requirements due to the intractable number of receptive nodes.

Accordingly, there is a need for an improved system, method, and computer readable medium for processing graph data structures that can reduce the number of computations required for such processing while maintaining a suitable level of accuracy.

### SUMMARY

According to a first example aspect, a method is disclosed for operating a computer system to process a graph, the graph comprising a data structure that defines nodes that represent entities and edges that represent relationships between the nodes, each node having an associated feature vector that specifies a set of feature values for the node. The method includes performing an inference process. The inference process includes receiving a prediction request for a subject node of the graph; obtaining a sparse node approximation for the subject node, the sparse node approximation defining a weighted combination of a subset of nodes of the graph as receptive nodes for the subject node; applying a neural network based transformation function based on the sparse node approximation to generate a node representation for the subject node; performing a prediction task based on the generated node representation to generate a prediction for the subject node; and outputting the prediction.

In some examples of the first example aspect, obtaining the sparse node approximation for the subject node comprises accessing a stored sparse data structure that identifies, for each of a plurality of the nodes of the graph including the subject node, a respective sparse vector that defines a respective subset of other nodes of the graph as the receptive nodes for that node and respective weight indices for the receptive nodes; and applying the neural network based transformation function to generate the node representation for the subject node comprises: (i) for each receptive node of the subject node, applying the neural network transformation function to the feature vector associated with the receptive node to generate a respective receptive node representation, and (ii) combining the respective receptive node representations according to the respective weight indices for the receptive nodes.

In some examples of one or more of the preceding aspects, the method includes, prior to performing the inference process, preforming a learning process to learn an approximation of a target graph neural network (GNN) encoder, comprising: collectively learning the respective sparse vectors for the nodes of the graph and a set of parameters for the neural network based transformation function with an objective of jointly optimizing (i) an accuracy of node representations generated by the neural network based transformation function relative to node representations generated by the target GNN encoder and (ii) a sparsity of the respective sparse vectors.

In some examples of one or more of the preceding aspects, the learning process is performed to enable during the inference process a collective time required for obtaining the sparse node approximation and generating the node representation for the subject node during the inference process to be is less than a time required for a corresponding inference by the target GNN encoder.

In some examples of one or more of the preceding aspects wherein collectively learning the sparse vectors and the set of parameters comprises: identifying, for each of the nodes, a respective candidate nodes that are a subset of the nodes of the graph, wherein the respective sparse vector for each node is learned based on identifying a subset of the respective candidate nodes for the node as the receptive nodes for the node.

In some examples of one or more of the preceding aspects, identifying the respective candidate nodes for each node comprises a random walk selection process.

In some examples of one or more of the preceding aspects, collectively learning the sparse vectors and the set of parameters comprises performing a plurality of training iterations that each comprise a first phase during which the respective sparse vectors are updated and a second phase during which the set of parameters for the neural network based transformation function are updated.

In some examples of one or more of the preceding aspects, a mini-batch of the nodes are processed during each of the training iterations.

In some examples of one or more of the preceding aspects, preforming the learning process comprises training a neural network based decoder to perform the prediction task based on node representations generated by the neural network based transformation function subsequent to completion of the collective learning of the respective sparse vectors and the set of parameters.

In some examples of one or more of the preceding aspects, the method is performed at a server, the prediction request is received through a network from a user devices, and outputting the prediction comprises sending the prediction through the network to the user device.

According to a further example aspect, a computer system is disclosed that is configured to perform the method of one or more of the preceding aspects.

According to a further example aspect, a computer readable medium is disclosed that stores non-transient instructions that configure a computer system to perform the method of one or more of the preceding aspects.

### BRIEF DESCRIPTION OF THE DRAWINGS

Reference will now be made, by way of example, to the accompanying drawings which show example embodiments of the present application, and in which:

FIG. 1 is a block schematic diagram illustrating a known on-line prediction solution for processing a graph data structure using a graph neural network model.

FIG. 2 is a block schematic diagram illustrating an on-line prediction solution for processing a graph data structure according to example aspects of this disclosure.

FIG. 3 is a pseudocode representation of an algorithm for training a sparse decomposition graph neural network encoder of the on-line prediction solution of FIG. 2.

FIG. 4 is a block schematic diagram illustrating an inference process performed by the sparse decomposition graph neural network encoder of FIG. 2.

FIG. 5 is a plot of accuracy against inference time for a variety of encoder structures illustrating improvement of the functioning of computer system by the sparse decomposition graph neural network encoder of the on-line prediction solution of FIG. 2.

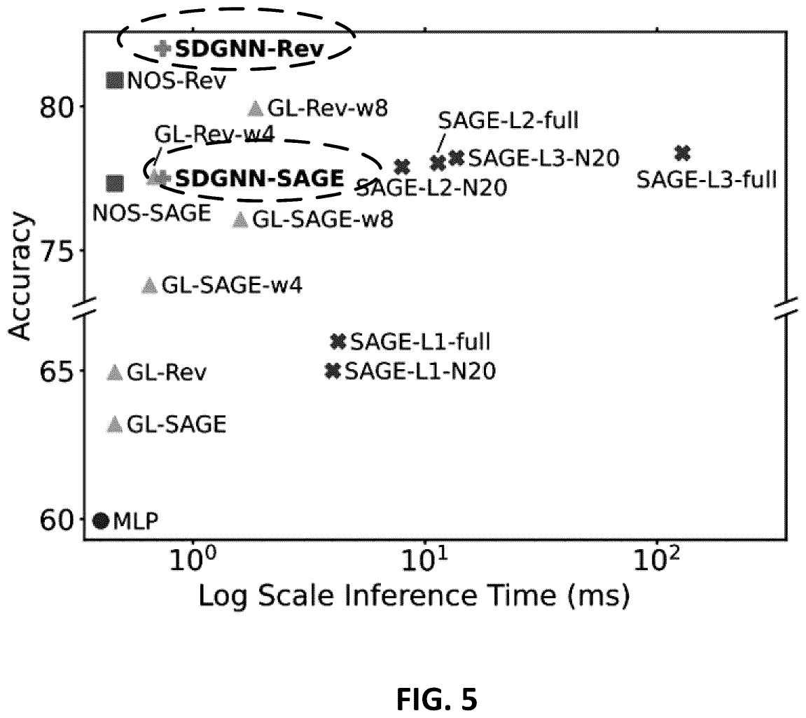

FIG. 6 is a block diagram of a processing unit on which one or more modules of the present disclosure may be implemented.

Similar reference numerals may have been used in different figures to denote similar components.

### DESCRIPTION OF EXAMPLE EMBODIMENTS

Example embodiments are directed towards a processing system, method, and computer readable medium for processing graph data structures that can reduce the number of computations (and thus inference time) required for such processing while maintaining a suitable level of accuracy. In example embodiments, the disclosed solution offers a sparse decomposition GNN (SDGNN) model that has linear complexity in terms of inference time (e.g., inference time is linear w.r.t. the number of layers of a GNN model and the average node degree (i.e., number of hops that define a neighbourhood)), while still enabling the most relevant neighbourhood features to be processed during inference. Furthermore, the disclosed SDGNN model is highly versatile in that it can be implemented in combination with a variety of known GNN architectures.

Context for example implementation of a disclosed solution is provided in the following paragraphs. Consider a graph [symbol] ={ [symbol] , [symbol] } with | [symbol] |=n nodes and | [symbol] |=m edges. Denote by X∈ [symbol] ^{n×D0} the feature matrix, with a dimension of D₀, in which the i^{th} row X_{i*} denotes the feature vector of node i. In known GNN solutions, graph representation learning involves learning an embedding g (z, X| [symbol] ) for each node z by training GNN encoder 106. The representations can then be applied in a downstream task using an encoder 108, e.g., node classification, link prediction, and graph classification. In a node classification task, encoder 108 outputs a label matrix Ŷ∈ [symbol] ^{n×K} where the i^{th} row Ŷ_{i*} is a one-hot encoded vector of K classes.

Given the labels for a subset of nodes in graph [symbol] , the node classification task is to predict the labels for unlabelled nodes of graph [symbol] . The graph [symbol] is associated with an adjacency matrix A∈ [symbol] ^{n×n}, where Aᵢⱼ: =1 if and only if the edge (i, j)∈ [symbol] , and otherwise Aᵢⱼ:=0.

As noted above in respect of equations (1) and (2), in a conventional GNN encoder g the direct inference of each node representation g(z, X| [symbol] ) is proportional to the number of receptive nodes. Specifically, for message-passing based GNN models, the number of receptive nodes potentially grows exponentially as the number of GNN layers increases. Accordingly, example implementations are directed to a GNN model solution that enables the number of nodes that are considered as receptive nodes to be substantially reduced. This is accomplished by applying an alternative node embedding approximating computation approach, ĝ(z, X| [symbol] ), so that inference computation complexity O( [symbol] L) is linear with respect to number of layers L and average node degree [symbol] , while approximate node representation ĝ(z, X| [symbol] ) remains sufficiently close to node representation g(z, X| [symbol] ) to enable accurate performance of downstream computations (e.g., prediction output by decoder 108).

Different metrics can be adopted to compare (e.g., measure the distance) between approximate node representation ĝ(z, X| [symbol] ) and original GNN node representation g(z, X|G). In an example implementation, normalized Euclidean distance is selected as a comparative metric, with normalized regret (NR) defined as:

$$NR := \frac{1}{\vert ν \vert} {\sum }_{z ∈ ν} \frac{{‖ \hat{g} ( z , X \vert 𝒢 ) - g ( z , X \vert 𝒢 ) ‖}_{2}^{2}}{{g ( z , X \vert 𝒢 ) ‖}_{2}^{2}} . \qquad Equation ( 3 )$$

The normalization makes the metric independent of the scale of the target embeddings. As long as the NR is small, the node representation from the approximate embedding ĝ(z, X| [symbol] ) can be adopted for any downstream tasks instead of the original GNN embedding.

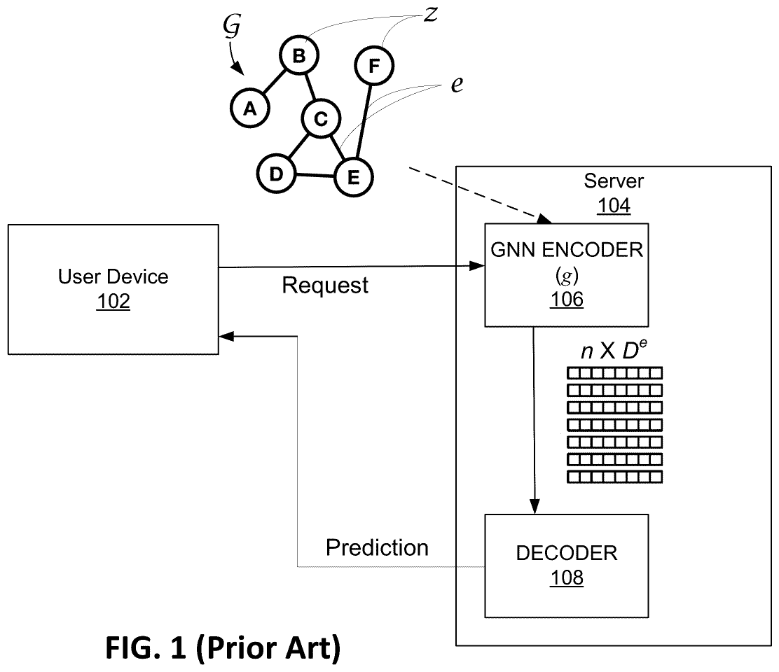

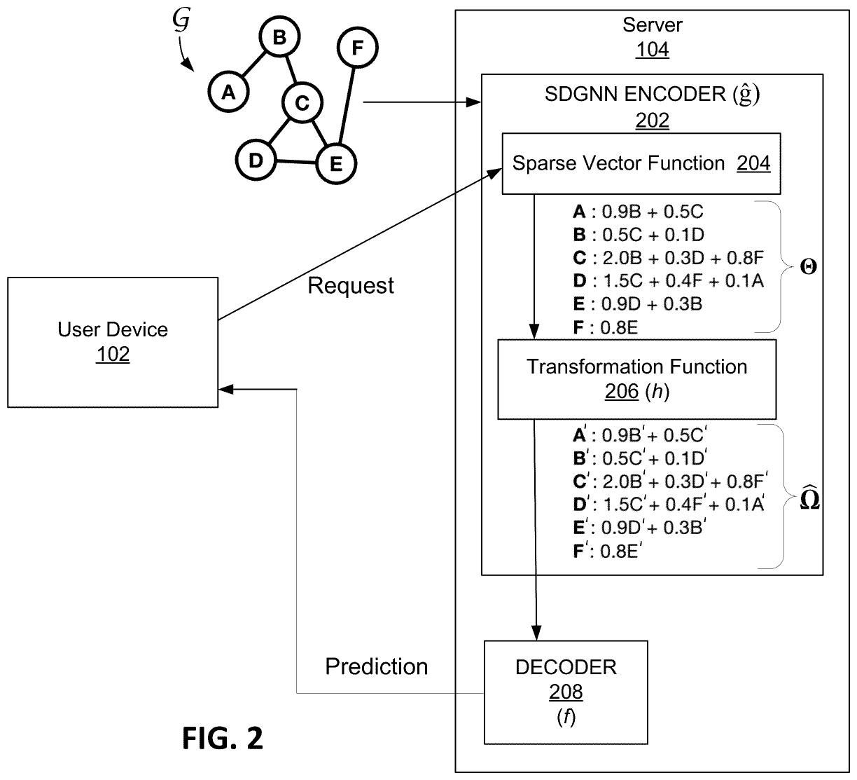

In this regard, FIG. 2 is a schematic representation of an online prediction system that is similar to that of FIG. 1 except that a target GNN encoder 106 is replaced with a sparse decomposition GNN (SDGNN) encoder 202. SDGNN encoder 202 is configured to accurately approximate a subject node representation generated by the target GNN encoder 106 (which may, for example, be a conventional message passing-based GNN model) but to generate that approximation using a much lower inference complexity. In order to do this, as will be described in detail below, SDGNN encoder 202 includes a sparse vector function 204 that applies a learnable sparse matrix (Θ) and a learnable transformation function (h) 206. The sparse matrix Θ generates a respective sparse node vector θ_{z}∈ [symbol] , for each graph node z. The transformation function h(·;W): [symbol] ^{D}→ [symbol] ^{D′} maps each row of an input feature matrix X∈ [symbol] to a predefined dimension D′, where W represents a set of learnable parameters. For conciseness, the notation is extended to the matrix setting, with h(X;W): [symbol] → [symbol] being the result of a row-wise mapping from X under the function h(·;W). Each node z is modelled as a linear combination over the transformed node features via its respective sparse node vector θ_{z}, such that the sparse decomposition performed by SDGNN encoder 202 for node z can be denoted as ĝ(z, X| [symbol] ):=θ_{z}^{T}h(X;W).

The sparsity of sparse node vector θ₂ and the node-wise dependency on h(·;W) ensure that the computation of representation ĝ(z, X| [symbol] ) depends on a limited set of node features. Hence, the inference complexity can be controlled to be O( [symbol] L). The sparse vector function 204 and transformation function (h) 206 collectively provide flexibility that enables SDGNN encoder 202 to approximate a large variation of target GNN models.

In this disclosure, at the matrix level SDGNN encoder 202 can be denoted as follows. Let (θ₁, θ₂, . . . , θ_{z|v|}) be the columns of the sparse matrix Θ. The target node representation matrix is denoted as Ω∈ [symbol] , where the z^{th} row Ω_{z*}:=ĝ(z, X| [symbol] ). Correspondingly, a predicted node representation matrix (e.g., the output of SDGNN encoder 202 is denoted as \hat{Ω}:=Θ^{t}h(X;W).

In example implementations, the transformation function h (·;W) is implemented using a neural network such as a multilayer perceptron (MLP). As known in the art, MLP is a misnomer for a modern feedforward artificial neural network, consisting of fully connected neurons with a nonlinear kind of activation function, organized in at least three layers. Any number of suitable MLP structures known for graph processing can be used for transformation function h (·;W), with specific examples disclosed below in the context of experimentation and evaluation.

The optimal sparse matrix Θ and optimal transformation function h(·;W) are jointly learned through a training process in respect of an input graph [symbol] that is provided with a target node representation matrix Ω. The target node representation matrix Ω can, for example, be the set of embeddings generated for graph [symbol] by the target GNN encoder 106 that SDGNN encoder 202 is being trained to approximate.

In example implementations, the optimal sparse matrix Θ and transformation function h(·;W) are learned by solving the following optimization problem:

$${minimize}_{Θ , h ( ? \text{W)}} \frac{1}{2} {‖ {Θ}^{T} h ( X ; W ) - Ω ‖}_{F}^{2} + {λ}_{1} {‖ Θ ‖}_{1 , 1} + {λ}_{2} {‖ W ‖}_{F}^{2} , \qquad Equation ( 4 )$$

where λ₁≥0 is a hyperparameter to control the sparsity of sparse matrix Θ via an L1 regularization term, and λ₂≥0 is the hyperparameter for L2 regularization of the transformation function parameters W. In the case where the transformation function h(X;W) is a multi-layer perceptron (MLP) model, the L2 regularization implicitly upper bounds the row-wise norm of h(X;W) for a given X. This prevents the degenerate case of an extremely small and sparse matrix Θ.

Jointly learning the respective sets of values for sparse matrix Θ and function parameters W can be challenging due to the sparsity constraint on sparse matrix Θ. In order to address this challenge, in example implementations, a two stage iterative training procedure is applied to optimize one set of values while fixing the other set of values. These two stages are referred to herein as Phase Θ and Phase h.

Phase Θ can be represented as follows. During each training iteration, for each node z∈ [symbol] , the respective sparse node vector θ_{z} is updated with the solution of the least absolute shrinkage and selection operator (Lasso) optimization problem:

$${arg min}_{θ} \frac{1}{2} ‖ {θ}^{T} h ( X ; W ) - {Ω}_{z *} {‖}_{2}^{2} + {λ}_{1} ‖ θ {‖}_{1} \qquad Equation ( 5 )$$

In at least some example implementations the constraint s.t. θ≥0 can be applied to Equation (5) to make the optimization procedure more robust.

In example implantations, the Least Angle Regression (LARS) algorithm [Reference: Efron, Bradley; Hastie, Trevor; Johnstone, Iain; Tibshirani, Robert (2004). “Least Angle Regression” (PDF). Annals of Statistics. 32 (2): pp. 407-499. arXiv: math/0406456] is applied to solve the optimization problem of Equation (5) due to its efficiency and capability of controlling the maximum number of nonzero entries.

Phase h can be represented as follows. In each training iteration, the parameter matrix W is updated based on solving the optimization problem:

$${arg min}_{W} \frac{1}{2} {‖ {Θ}^{T} h ( X ; W ) - Ω ‖}_{F}^{2} + {λ}_{2} {‖ W ‖}_{F}^{2} . \qquad Equation ( 6 )$$

In an example implementation, a common gradient descent (GD) algorithm can be used to solve for W. In some examples, rather than reaching a converged W, a few steps are taken as part of each training iteration.

In some examples, training is performed on a mini-batch basis as part of each training iteration. Specifically, [symbol] ⊂ [symbol] nodes are randomly selected at each iteration and only the respective sparse node vectors θ_{z} for nodes z∈ [symbol] are updated. In the case of parameters W, the same subset [symbol] of nodes are selected and the corresponding rows of θ^{t}h(X; W)−Ω to include in the loss term for each mini-batch, to solve the optimization problem:

$${arg min}_{W} \frac{1}{2} {\sum }_{s ∈ 𝔹} ‖ {θ}_{z}^{T} h ( X ; W ) - {Ω}_{z *} {‖}_{2}^{2} + {λ}_{2} ‖ θ {‖}_{F}^{2} , \qquad Equation ( 7 )$$

In some examples, a preliminary step of culling some nodes can be performed at server 104 prior to sparse vector function 204. In particular, the number of computations required can grow rapidly as the size n of node set [symbol] increases. Specifically, the computational overhead comes from the inference time of h(X; W) and the computation time to solve the optimization problem of Equation (5). To reduce the required computation, in example implementations a preliminary step is performed to define a much smaller candidate node set [symbol] for each node z and only this smaller set of candidate nodes are processed to determine the respective sparse node vector θ_{z} for each node z.

In such implementations, the optimization problem represented by Equation (5) is replaced the following problem instead:

$${argmin}_{θ} \frac{1}{2} ‖ {θ}^{T} h ( X ; W ) - {Ω}_{z *} {‖}_{2}^{2} + {λ}_{1} ‖ θ {‖}_{1} \qquad Equation ( 8 )$$

$$s . t . {θ}_{i} \geq 0 ∀ i ∈ {ℂ}_{z} , {θ}_{i} = 0 ∀ i ∉ {ℂ}_{z} . \qquad Equation ( 9 )$$

Equation (9) defines the reduced candidate set for solving sparse node vector θ_{z}. In such case, the inference h(X; W) only has to be performed for node z that appears in the candidate node set [symbol] and the complexity of solving Equation (8) only depends on the size of the candidate node set [symbol] instead of the full set of graph nodes.

In example embodiments, the candidate node set [symbol] can be selected by using knowledge of the structure of graph [symbol] (as represented in adjacent matrix A) to heuristically determine the candidate node set [symbol] for each node z with an objective of including the most relevant nodes with a moderate-sized candidate set. In a particular example, candidate node set [symbol] for a subject node z is the union of all K₁-hop neighbours of subject node z together with nodes visited during a K₂-hop random walk for K₂>K₁. In some examples, K₂=K₁+2 and the smallest K₁ is selected that yields an acceptable combination of speed and accuracy. In some examples K₁=1. In some examples K₁=2. In some examples K₁=3 or greater.

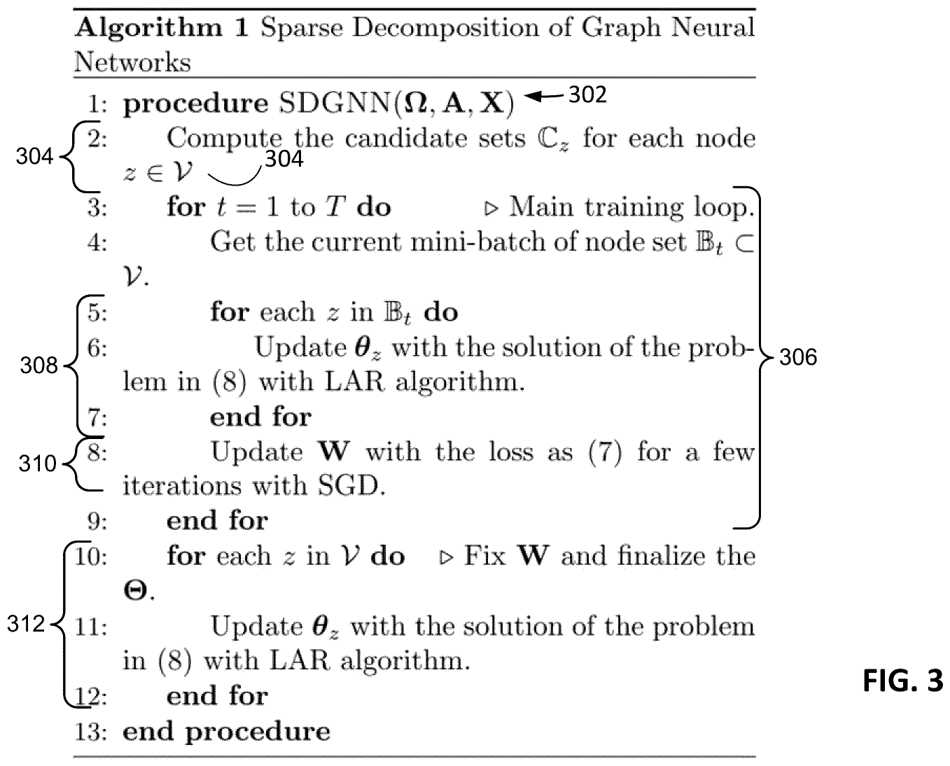

An example of a method for training the SDGNN encoder (ĝ) 202 at server 104 that applies the two stage process described above is illustrated in pseudocode form by Algorithm 1 of FIG. 3, where numbers in parenthesis correspond to the above Equations. As set out in FIG. 3, the training algorithm for SDGNN Encoder 202 can be summarized as follows.

Step 1 (302): The following inputs are obtained: (1) a representation of graph [symbol] , in the form of node feature matrix X and adjacent matrix A; and (2) target node representation matrix Ω. (As noted above, target node representation matrix Ω can be the set of embeddings generated for graph [symbol] by a target GNN encoder 106 that SDGNN encoder 202 is being trained to approximate.)

Step 2 (304): In at least some examples, a preliminary node selection procedure is performed to determine for each node z, a respective set of candidate nodes [symbol] (from the total set of nodes [symbol] ) that are to be considered when determining the sparse node vector θ_{z} for that node. For example, as noted above, candidate node set [symbol] for a subject node z can be the union of all K₁-hop neighbours of subject node z together with nodes visited during a K₂-hop random walk for K₂>K₁.

Step 3 (306): A main training loop is performed for T iterations. In the illustrated example, the training is done in mini-batches as described above, such that for each iteration [symbol] nodes are randomly selected from [symbol] for processing. Each iteration of the main training loop comprises, two phases, namely: Phase Θ (308), during which for each node z∈ [symbol] , the respective sparse node vector θ_{z} is updated to solve the optimization problem represented by Equations (8) and (9) using a LARS algorithm; and Phase h (310), during which a GD algorithm is performed for a few iterations as per Equation (7) to update the parameter matrix W of transformation function (h).

Step 4 (312): Finally, for each node z in node set [symbol] , fix the parameters of function transformation function (h) and apply a LARS algorithm to solve the optimization problem represented by Equations (8) and (9) and update the sparse node vector θ_{z}.

To provide further illustration of the training of SDGNN encoder (ĝ) 202, reference is made to FIG. 2 and illustrative Graph G that contains nodes A, B, C, D, E, and F, having respective feature vectors X_{A}, X_{B}, X_{C}, X_{D}, X_{E}, X_{F}. At the completion of training, the sparse node approximation for node A is the weighted linear combination of 0.9X_{B}+0.5 X_{C}, where the sparse node vector θ_{z}=(0, 0.9, 0.5, 0, 0, 0).

Thus, nodes B and C are considered receptive nodes for Node A, with respective weighting indices of 0.9 and 0.5. In matrix form, the sparse matrix Θ, which includes sparse vector representations θ_{z} for all nodes z in [symbol] can be represented as follows:

TABLE 1
Sparse Matrix Θ

| | X_{A} | X_{B} | X_{C} | X_{D} | X_{E} | X_{F} |
|---|---|---|---|---|---|---|
| θ_{A} | | 0.9 | 0.5 | | | |
| θ_{B} | | | 0.5 | 0.1 | | |
| θ_{C} | | 2.0 | | 0.3 | | 0.8 |
| θ_{D} | 0.1 | | 1.5 | | | 0.4 |
| θ_{E} | | 0.3 | | 0.9 | | |
| θ_{F} | | | | | 0.8 | |

The sparse matrix Θ includes non-zero indices that identify, for each subject node z a sparse node vector θ_{z} indicating the subject node's respective receptor nodes and a respective index value (weight) for each of the receptor nodes. Non-receptor nodes are assigned a null or 0 value in the sparse matrix Θ.

The sparse matrix Θ and feature matrix X can be provided as inputs to transformation function (h) to generate predicted node representation matrix \hat{Ω}:=Θ^{T}h(X; W) in the form illustrated in FIG. 2. It will be appreciated that the number of per node computations that need to be performed by transformation function (h) relative to the target GNN encoder 106 are greatly reduced due to the sparsity of nodes specified in the sparse matrix Θ. The sparse matrix Θ is stored by server 104 for future use.

In example implantations, once SDGNN encoder 202 is trained to approximate target GNN encoder 106, a corresponding decoder (f) 208 can then be trained. In particular, SDGNN encoder 202 is used to generate node representation matrix \hat{Ω}:=Θ^{T}h(X; W), which includes a respective SDGNN node representation \hat{Ω}_{Z*}:=ĝ(z, X| [symbol] ) for each node z. In the case of a classification task, the decoder (f) 208 is then trained to map the SDGNN node representation Ω_{z*} for each node having a pre-known label to its respective label Y₂. In at least some examples, at least some of the known labels may be soft labels obtained by training the target encoder 106 and its respective decoder 108.

Accordingly, using the known labels and the node representation ĝ (z, X| [symbol] ) for each node z from SDGNN encoder 202, decoder 208 is trained to map the node representations to the predicted labels. In some examples, an MLP NN model may be used for the decoder and the decoder can be trained using, for example, a cross-entropy loss for classification tasks and mean squared error for regression tasks.

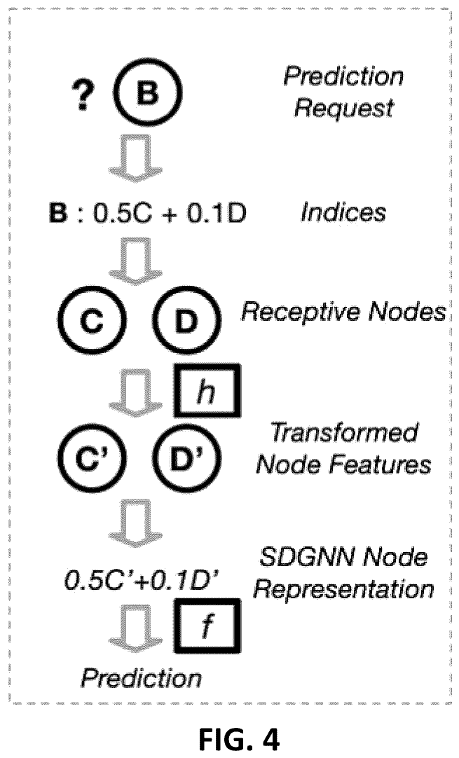

FIG. 4 illustrates an example of post-training operation of server 104. In the illustrated example, server 104 receives a request from the user device 102 for a prediction (for example, in the context of a classification task) in respect of node B of the Graph [symbol] . As indicated above in the example of Table 1, sparse matrix Θ includes data that indicating the receptive nodes for each subject node in Graph [symbol] and index values indicating a weight value for those receptive nodes. Accordingly, server 104 consults sparse matrix Θ to look up what weighted combination of other nodes can be used to approximate node B, which in the case of the example of Table 1 is B≈0.5X_{C}+0.1 X_{D}. Server 104 obtains the most recent feature vectors X_{C}, X_{D} that are known for Graph [symbol] . In some examples, this information may be requested by server 104 from user device 102 or another source of current graph data. In other examples, a current version of Graph G may be maintained and stored at Server 104.

Server 104 applies transformation function (ĝ) to each of the respective feature vectors X_{C} and X_{D} to obtain representations C′ and D′. These individual transformed representations for the receptor nodes are then combined as per the weightings specified in sparse matrix Θ, namely 0.5C′+0.1D′ to provide an embedding (e.g., node embedding) ĝ (z, X| [symbol] ) for subject node B (shown in FIG. 4 as SDGNN Node representation 0.5C′+0.1D′).

The resulting node embedding ĝ(z, X| [symbol] ) for subject node B is then provided to decoder (f) to provide a prediction. The prediction is then returned to user device 102.

It will be noted that the prediction for node B can be generated using only the feature vectors for nodes C and D. This can substantially reduce the amount of feature node data that the server 104 needs to obtain to perform a prediction, as well the number of computations required to arrive at the prediction. Thus, performance and operation of the computer system used to implement server 104 can be improved when compared to using the original target encoder [symbol] . The latency between receiving a request for a node prediction and then providing that prediction can be substantially reduced, while still maintaining prediction accuracy.

Among other things, once trained, SDGNN encoder (ĝ) 202 can be applied to node classification tasks in a dynamic node environment where the features of nodes in the graph [symbol] can change over time, requiring updated predictions. In some cases, SDGNN encoder (ĝ) 202 can also be used in link prediction tasks.

The effectiveness of the disclosed SDGNN encoder (ĝ) 202 methods and architecture of improving the functioning of a computer system such as server 104 is illustrated with reference to following experimental and evaluation data.

Datasets: Evaluations were conducted using the following datasets: Cora, Citeseer, Pubmed, Computer, Photo, Arxiv and Products.

Baseline Model Architectures: (1) GLNN (Zhang, S., Liu, Y., Sun, Y., and Shah, N. (2021). Graph-less neural networks: Teaching old mlps new tricks via distillation. In Proc. Int. Conf. on Learn. Representations); (2) NOSMOG (Tian, Y., Zhang, C., Guo, Z., Zhang, X., and Chawla, N. (2023). Learning mlps on graphs: A unified view of effectiveness, robustness, and efficiency. In Proc. Int. Conf. on Learn. Representations) as baselines representing techniques that aim to infer any targeted GNN model with linear complexity. (3) Ã³ Model: baseline constructed by selecting receptive nodes and deriving approximate weights using Ã³, the third power of the symmetric normalized adjacent matrix, Ã=D^{-1/2} AD^{-1/2}, where D is the diagonal degree matrix. In particular, an estimate Ã³X is formed.

Target GNN models: (1) GraphSAGE (Hamilton, W., Ying, Z., and Leskovec, J. (2017). Inductive representation learning on large graphs. In Proc. Advances in Neural Information Processing Systems.) with mean aggregator for all the datasets. (2) Geom-GCN (Pei, H., Wei, B., Chang, K. C.-C., Lei, Y., and Yang, B. (2020). Geom-gcn: Geometric graph convolutional networks. In Proc. Int. Conf. on Learn. Representations) for Cora, Citeseer and Pubmed datasets. (3) Exphormer (Shirzad, H., Velingker, A., Venkatachalam, B., Sutherland, D. J., and Sinop, A. K. (2023). Exphormer: Sparse transformers for graphs. In Proc. Int. Conf. Machine Learning.) for Computer and Photo datasets.; (4) DRGAT (Zhang, L., Yan, X., He, J., Li, R., and Chu, W. (2023). Drgcn: Dynamic evolving initial residual for deep graph convolutional networks. In Proc. of the AAAI Conf. on Artificial Intelligence.) for Arxiv dataset. (5) RevGNN-112 (RevGNN) (Li, G., M\ddot{ } uller, M., Ghanem, B., and Koltun, V. (2021). Training graph neural networks with 1000 layers. In Proc. Int. Conf. Machine Learning.) for Products dataset.

For these evaluations, the representation of the second last layer of each of the target models was adopted as the target node embeddings. Evaluation was focused on the transductive setting. For the 5 small datasets (Cora, Citeseer, Pubmed, Computer and Photo), nodes were randomly split with a 6:2:2 ratio into training, validation and testing sets. Experiments are conducted using 10 random seeds, as in (Pei, H., Wei, B., Chang, K. C.-C., Lei, Y., and Yang, B. (2020). Geom-gcn: Geometric graph convolutional networks. In Proc. Int. Conf. on Learn. Representation). For Arxiv and Products, the fixed predefined data splits that were used are those specified in (Hu, W., Fey, M., Zitnik, M., Dong, Y., Ren, H., Liu, B., Catasta, M., and Leskovec, J. (2020). Open graph benchmark: Datasets for machine learning on graphs. In Proc. Advances in Neural Information Processing Systems.) and the experiments run 10 times and report the mean and standard deviation.

Node Representation: Table 2 below shows the effectiveness of SDGNN encoder in approximating the node representations of the target GNN models according to a normalized regret metric (2), with the worst performance on Arxiv with SAGE model (0.11).

TABLE 2
Performance on node representation approximation and node classification tasks.

| Data/Target Model | Original ↑ | GLNN ↑ | NOSMOG ↑ | SDGNN ↑ | SDGNN NR ↓ |
|---|---|---|---|---|---|
| Cora/SAGE | 85.25 ± 1.43 | 86.86 ± 1.39 | 85.82 ± 1.39 | 85.77 ± 1.24 | 0.01 ± 0.01 |
| Cora/Geom-GCN | 86.43 ± 0.98 | 85.78 ± 1.26 | 85.68 ± 1.01 | 85.82 ± 0.76 | 0.02 ± 0.01 |
| Citeseer/SAGE | 73.79 ± 1.63 | 76.89 ± 1.53 | 76.41 ± 1.39 | 74.86 ± 1.54 | 0.01 ± 0.00 |
| Citeseer/Geom-GCN | 79.79 ± 0.94 | 79.34 ± 1.40 | 79.88 ± 0.93 | 80.13 ± 1.14 | 0.03 ± 0.01 |
| Pubmed/SAGE | 85.40 ± 0.58 | 89.21 ± 0.66 | 87.98 ± 0.62 | 85.42 ± 0.60 | 0.03 ± 0.00 |
| Pubmed/Geom-GCN | 89.79 ± 0.43 | 90.88 ± 0.53 | 90.31 ± 0.59 | 89.31 ± 0.49 | 0.04 ± 0.01 |
| Computer/SAGE | 89.09 ± 0.70 | 88.49 ± 0.72 | 89.29 ± 0.74 | 90.67 ± 0.54 | 0.005 ± 0.001 |
| Computer/Exphormer | 91.43 ± 0.58 | 92.24 ± 0.71 | 93.28 ± 0.62 | 94.38 ± 0.58 | 0.01 ± 0.00 |
| Photo/SAGE | 93.05 ± 0.52 | 93.87 ± 0.33 | 94.27 ± 0.50 | 93.90 ± 0.57 | 0.004 ± 0.003 |
| Photo/Exphormer | 93.05 ± 0.48 | 95.58 ± 0.56 | 95.35 ± 0.52 | 96.53 ± 0.37 | 0.02 ± 0.03 |
| Arxiv/SAGE | 70.23 ± 0.23 | 63.40 ± 0.23 | 69.78 ± 0.22 | 69.72 ± 0.29 | 0.11 ± 0.00 |
| Arxiv/DRGAT | 73.78 ± 0.09 | 65.92 ± 0.17 | 72.16 ± 0.15 | 73.14 ± 0.16 | 0.10 ± 0.01 |
| Products/SAGE | 78.37 ± 0.55 | 62.87 ± 0.53 | 77.33 ± 0.32 | 77.51 ± 0.25 | 0.08 ± 0.00 |
| Products/ReyGNN | 82.79 ± 0.25 | 64.49 ± 0.17 | 80.91 ± 0.23 | 82.02 ± 0.24 | 0.03 ± 0.01 |

In most cases, the representations generated by the SDGNN encoder is close to the target GNN models. Performance on Downstream Tasks. Table 2 show comparisons of SDGNN encoder accuracy among GLNN, NOSMOG and SDGNN for all seven datasets with different target GNN models. The SDGNN encoder approximates the target model well for all scenarios and achieve close or better accuracy. The largest negative discrepancy is 0.77 percent for Products/RevGNN. GLNN and NOSMOG often outperform the SAGE target model. However, for the better-performing models on the larger datasets, Arxiv and Products, the performance gap with respect to the target model is more pronounced. For example, on Products/RevGNN the performance gaps are 18.39 and 1.88 percent, respectively. One of the most important differences between GLNN and NOSMOG is that NOSMOG calculates a positional encoding (derived using DeepWalk) for each node and stores this as an additional feature. For Products and Arxiv, this positional encoding is clearly playing a critical role. This suggests that NOSMOG is partially learning a static mapping from node position to label. This would prevent NOSMOG from being used in online inference, whereas the SDGNN encoder can be used in environments where node features and labels can change.

Inference Time: Inference was performed for 10,000 randomly sampled nodes for each dataset to assess the trade-off between inference time and accuracy. FIG. 2 illustrates the testing accuracy versus the average computation time per node for different models and approximation techniques. It will be noted that SDGNNRev (SDGNN encoder based on RevGNN) achieves the best accuracy (82.02%) with fast inference time (0.74 ms), while the MLP-based methods (MLP, GL-Rev, GLSAGE, NOS-SAGE, NOS-Rev) have the fastest inference time (approximately 0.45 ms). The SDGNN encoder is marginally slower due to the additional computation costs of performing feature transformation on multiple nodes and aggregation to incorporate neighbour features. The SAGE series, such as SAGE-L3-full (a 3-layer SAGE model without sampling during inference) and SAGE-L2-N20 (a 2-layer SAGE model that samples 20 neighbours), exhibit rapidly growing inference times as the number of layers increases (up to 128 ms), making them impractical for real-world applications. The results for GL-SAGE-w4 (a version of GL-SAGE with hidden dimension 4 times wider) and GL-Rev-w4 (a 4 times wider version of GL-Rev), are also illustrated in FIG. 2. Although their accuracy improves compared to their base versions, their inference times also increase substantially. Thus, it will be noted that the SDGNN encoder offers superior performance in terms of accuracy, and its inference time is comparable to the fastest MLP models.

Receptive Nodes: Table 3 below shows the average number of receptive nodes for the SDGNN encoder, the candidate set (as described above) and original graph within 3-hop neighbours for each node. In summary, the SDGNN encoder can effectively select a small set of receptive nodes to approximate the node embedding from a target GNN model.

TABLE 3
The average number of receptive nodes for each node.

| | | | 3-hop |
|---|---|---|---|
| Data/Target model | SD-GNN | Candidate | Neigh. |
| Arxiv/SAGE | 28.4 | 305.0 | 19170.1 |
| Arxiv/DRGAT | 27.6 | 286.1 | 19170.1 |
| Products/SAGE | 21.6 | 379.2 | 66951.6 |
| Products/RevGNN-112 | 20.9 | 377.4 | 66951.6 |

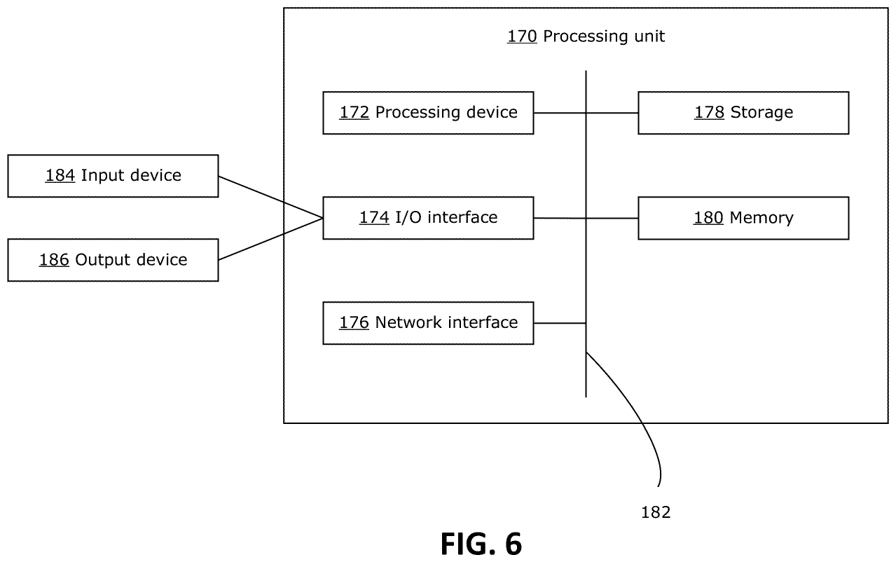

FIG. 6 is a block diagram of an example processing unit 170, which may be used to implement one or more of the computer systems shown in FIG. 2, including for example server 104. Processing unit 170 may be used in a computer device to execute machine executable instructions that implement one or more of the modules or parts of the modules of system 100. Other processing units suitable for implementing embodiments described in the present disclosure may be used, which may include components different from those discussed below.

The processing unit 170 may include one or more processing devices 172, such as a processor, a microprocessor, a general processor unit (GPU), a hardware accelerator, an application-specific integrated circuit (ASIC), a field-programmable gate array (FPGA), a dedicated logic circuitry, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network (for example a network linking user device 102 and server 104)

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory (ies) 180 may store instructions for execution by the processing device(s) 172, such as to carry out examples described in the present disclosure. The memory (ies) 180 may include other software instructions, such as for implementing an operating system and other applications/functions.

There may be a bus 182 providing communication among components of the processing unit 170, including the processing device(s) 172, I/O interface(s) 174, network interface(s) 176, storage unit(s) 178 and/or memory (ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of any publications identified in this disclosure are incorporated herein by reference in their entirety.

1. A method of operating a computer system to process a graph, the graph comprising a data structure that defines nodes that represent entities and edges that represent relationships between the nodes, each node having an associated feature vector that specifies a set of feature values for the node, the method comprising:
performing an inference process comprising:
receiving a prediction request for a subject node of the graph;
obtaining a sparse node approximation for the subject node, the sparse node approximation defining a weighted combination of a subset of nodes of the graph as receptive nodes for the subject node;
applying a neural network based transformation function based on the sparse node approximation to generate a node representation for the subject node;
performing a prediction task based on the generated node representation to generate a prediction for the subject node; and
outputting the prediction.

2. The method of claim 1 wherein:
obtaining the sparse node approximation for the subject node comprises accessing a stored sparse data structure that identifies, for each of a plurality of the nodes of the graph including the subject node, a respective sparse vector that defines a respective subset of other nodes of the graph as the receptive nodes for that node and respective weight indices for the receptive nodes; and
applying the neural network based transformation function to generate the node representation for the subject node comprises: (i) for each receptive node of the subject node, applying the neural network transformation function to the feature vector associated with the receptive node to generate a respective receptive node representation, and (ii) combining the respective receptive node representations according to the respective weight indices for the receptive nodes.

3. The method of claim 2 comprising, prior to performing the inference process, preforming a learning process to learn an approximation of a target graph neural network (GNN) encoder, comprising:
collectively learning the respective sparse vectors for the nodes of the graph and a set of parameters for the neural network based transformation function with an objective of jointly optimizing (i) an accuracy of node representations generated by the neural network based transformation function relative to node representations generated by the target GNN encoder and (ii) a sparsity of the respective sparse vectors.

4. The method of claim 3 wherein the learning process is performed to enable a collective time required for obtaining the sparse node approximation and generating the node representation for the subject node during the inference process to be less than a time required for a corresponding inference by the target GNN encoder.

5. The method of claim 3 wherein collectively learning the sparse vectors and the set of parameters comprises:
identifying, for each of the nodes, respective candidate nodes that are a subset of the nodes of the graph, wherein the respective sparse vector for each node is learned based on identifying a subset of the respective candidate nodes for the node as the receptive nodes for the node.

6. The method of claim 5 wherein identifying the respective candidate nodes for each node comprises a random walk selection process.

7. The method of claim 3 wherein collectively learning the sparse vectors and the set of parameters comprises performing a plurality of training iterations that each comprise a first phase during which the respective sparse vectors are updated and a second phase during which the set of parameters for the neural network based transformation function are updated.

8. The method of claim 7 wherein a mini-batch of the nodes are processed during each of the training iterations.

9. The method of claim 3 wherein preforming the learning process comprises training a neural network based decoder to perform the prediction task based on node representations generated by the neural network based transformation function subsequent to completion of the collective learning of the respective sparse vectors and the set of parameters.

10. The method of claim 1 wherein the method is performed at a server, the prediction request is received through a network from a user devices, and outputting the prediction comprises sending the prediction through the network to the user device.

11. A system comprising one or more processing devices and one or more memories, and being configured for processing a graph, the graph comprising a data structure that defines nodes that represent entities and edges that represent relationships between the nodes, each node having an associated feature vector that specifies a set of feature values for the node, the processing comprising:
performing an inference process comprising:
receiving a prediction request for a subject node of the graph;
obtaining a sparse node approximation for the subject node, the sparse node approximation defining a weighted combination of a subset of nodes of the graph as receptive nodes for the subject node;
applying a neural network based transformation function based on the sparse node approximation to generate a node representation for the subject node;
performing a prediction task based on the generated node representation to generate a prediction for the subject node; and
outputting the prediction.

12. The system of claim 11 wherein:
obtaining the sparse node approximation for the subject node comprises accessing a stored sparse data structure that identifies, for each of a plurality of the nodes of the graph including the subject node, a respective sparse vector that defines a respective subset of other nodes of the graph as the receptive nodes for that node and respective weight indices for the receptive nodes; and
applying the neural network based transformation function to generate the node representation for the subject node comprises: (i) for each receptive node of the subject node, applying the neural network transformation function to the feature vector associated with the receptive node to generate a respective receptive node representation, and (ii) combining the respective receptive node representations according to the respective weight indices for the receptive nodes.

13. The system of claim 12, the processing comprising, prior to performing the inference process, preforming a learning process to learn an approximation of a target graph neural network (GNN) encoder, comprising:
collectively learning the respective sparse vectors for the nodes of the graph and a set of parameters for the neural network based transformation function with an objective of jointly optimizing (i) an accuracy of node representations generated by the neural network based transformation function relative to node representations generated by the target GNN encoder and (ii) a sparsity of the respective sparse vectors.

14. The system of claim 13 wherein the learning process is performed to enable a collective time required for obtaining the sparse node approximation and generating the node representation for the subject node during the inference process to be less than a time required for a corresponding inference by the target GNN encoder.

15. The system of claim 13 wherein collectively learning the sparse vectors and the set of parameters comprises:
identifying, for each of the nodes, respective candidate nodes that are a subset of the nodes of the graph, wherein the respective sparse vector for each node is learned based on identifying a subset of the respective candidate nodes for the node as the receptive nodes for the node.

16. The system of claim 15 wherein identifying the respective candidate nodes for each node comprises a random walk selection process.

17. The system of claim 13 wherein collectively learning the sparse vectors and the set of parameters comprises performing a plurality of training iterations that each comprise a first phase during which the respective sparse vectors are updated and a second phase during which the set of parameters for the neural network based transformation function are updated.

18. The system of claim 17 wherein a mini-batch of the nodes are processed during each of the training iterations.

19. The system of claim 13 wherein preforming the learning process comprises training a neural network based decoder to perform the prediction task based on node representations generated by the neural network based transformation function subsequent to completion of the collective learning of the respective sparse vectors and the set of parameters.

20. A computer readable medium storing non-transient instructions for configuring a computer system to process a graph, the graph comprising a data structure that defines nodes that represent entities and edges that represent relationships between the nodes, each node having an associated feature vector that specifies a set of feature values for the node, the processing comprising:
performing an inference process comprising:
receiving a prediction request for a subject node of the graph;
obtaining a sparse node approximation for the subject node, the sparse node approximation defining a weighted combination of a subset of nodes of the graph as receptive nodes for the subject node;
applying a neural network based transformation function based on the sparse node approximation to generate a node representation for the subject node;
performing a prediction task based on the generated node representation to generate a prediction for the subject node; and
outputting the prediction.
